(19) United States
(12) Patent Application Publication
(10) Pub. No.: US 2010/0172317 A1
(43) Pub. Date: Jul. 8, 2010

(54) METHOD AND APPARATUS FOR ENERGY-EFFICIENT PAGING AND RECONNECTING DEVICES

(75) Inventors: Krishnan Rajamani, San Diego, CA (US); Samir S. Soliman, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/349,836

(22) Filed: Jan. 7, 2009

(51) Int. Cl. H04W 74/00

(52) U.S. Cl. 370/330

(57) ABSTRACT

An apparatus and method for paging and reconnecting comprising selecting a time frequency code (TFC) channel from a plurality of TFC channels; starting a beacon period (BP) on the selected TFC channel; and transmitting a plurality of page packets on the selected TFC channel. In one aspect, the apparatus and method further comprising receiving at least one page packet from a plurality of page packets; identifying a selected TFC channel from a plurality of TFC channels; obtaining at least one time reference; and performing one of joining a beacon period (BP) at a next beacon period start time (BPST) (380) or joining the selected TFC channel by sending a connect request message at a next device notification time slot (DNTS).

### FIELD

This disclosure relates generally to apparatus and methods for paging and reconnecting devices. More particularly, the disclosure relates to energy-efficient paging and reconnecting two mobile devices.

### BACKGROUND

Wireless devices allow communication between mobile users for basic digital voice services as well as for digital data services at various data rates. Such devices typically have a small form factor to facilitate portability and user ease. In particular, wireless devices usually rely on a rechargeable battery to provide a lightweight and portable energy source. The wireless access connection may employ space division multiple access (SDMA), frequency division multiple access (FDMA), time division multiple access (TDMA), code division multiple access (CDMA) and/or orthogonal frequency division multiple access (OFDMA) to allow a plurality of user equipments (UEs) to access the wireless communication system. One wireless access technology is known as ultra wideband (UWB), which is a peer-to-peer wireless technology for short-range communication between devices.

In one example, two UWB devices have discovered (i.e., located and contacted) each other and have subsequently completed initial acquisition and connection. A beacon group (BG) is a set of devices from which a device receives beacons that identify the same beacon period start time (BPST) as the device. After some period of time, either the first or the second or both UWB devices leave the Beacon Group (BG); that is, the connection between the two UWB devices is broken. Subsequently, the two UWB devices require re-discovery and reconnection. Typically, the UWB devices save the peer state from the previous connection in a non-volatile memory (NVM). The peer state includes, for example, the time frequency code (TFC), the medium access control (MAC) layer extended unique identifier (EUI) address, etc. The saved peer state may facilitate the re-discovery and reconnection.

In one example, Bluetooth, another wireless technology at a much lower throughput rate than UWB, uses a page/page-scan operation for re-discovery. In this technology, the paging unit sends successive page packets on different hop frequencies, which consumes energy while hopping between hop frequencies. Conventionally, the MAC/Physical layer specification for UWB devices, European Computer Manufacturers Association (ECMA) standard ECMA368, defines procedures for re-discovery and reconnection which consume more energy than what is acceptable or desired for battery-operated mobile devices such as mobile phones and personal digital assistants (PDAs), etc. The conventional re-discovery and reconnection procedures for UWB devices are not at a sufficiently energy-efficient level to minimize battery depletion and extend battery life as desired.

### SUMMARY

Disclosed is an apparatus and method for paging/reconnecting two UWB devices in an energy-efficient manner. According to one aspect, a method for paging and reconnecting two UWB devices comprising selecting a time frequency code (TFC) channel from a plurality of TFC channels; starting a beacon period (BP) on the selected TFC channel; and transmitting a plurality of page packets on the selected TFC channel.

According to another aspect, a method for reconnecting two UWB devices comprising receiving at least one page packet from a plurality of page packets; identifying a selected TFC channel from a plurality of TFC channels; obtaining at least one time reference; and performing one of joining a beacon period (BP) at a next beacon period start time (BPST) (380) or joining the selected TFC channel by sending a connect request message at a next device notification time slot (DNTS).

According to another aspect, an apparatus for paging and reconnecting comprising at least one processor and circuitry configured to: select a time frequency code (TFC) channel from a plurality of TFC channels; start a beacon period (BP) on the selected TFC channel; and transmit a plurality of page packets on the selected TFC channel.

According to another aspect, an apparatus for reconnecting comprising at least one processor and circuitry configured to: receive at least one page packet from a plurality of page packets; identify a selected TFC channel from a plurality of TFC channels; obtain at least one time reference; and perform one of joining a beacon period (BP) at a next beacon period start time (BPST) or joining the selected TFC channel by sending a connect request message at a next device notification time slot (DNTS).

According to another aspect, a UWB device for paging and reconnecting comprising means for selecting a time frequency code (TFC) channel from a plurality of TFC channels; means for starting a beacon period (BP) on the selected TFC channel; and means for transmitting a plurality of page packets on the selected TFC channel.

According to another aspect, a UWB device for reconnecting comprising means for receiving at least one page packet from a plurality of page packets; means for identifying a selected TFC channel from a plurality of TFC channels; means for obtaining at least one time reference; and means for performing one of joining a beacon period (BP) at a next beacon period start time (BPST) or joining the selected TFC channel by sending a connect request message at a next device notification time slot (DNTS).

According to another aspect, a computer program product, comprising a computer-readable medium including program codes stored thereon, comprising program codes for selecting a time frequency code (TFC) channel from a plurality of TFC channels; program codes for starting a beacon period (BP) on the selected TFC channel; and program codes for transmitting a plurality of page packets on the selected TFC channel.

According to another aspect, a computer program product, comprising a computer-readable medium including program codes stored thereon, comprising program codes for receiving at least one page packet from a plurality of page packets; program codes for identifying a selected TFC channel from a plurality of TFC channels; program codes for obtaining at least one time reference; and program codes for performing one of joining a beacon period (BP) at a next beacon period start time (BPST) or joining the selected TFC channel by sending a connect request message at a next device notification time slot (DNTS).

Advantages of the present disclosure include paging and reconnecting UWB devices while consuming less power and therefore extending battery life and operational duration.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example block diagram of a wireless communication system.

FIG. 2 illustrates an example UWB timeline showing parameters which impact energy efficiency of the UWB devices.

FIG. 3 illustrates an example flow diagram for paging/reconnecting two UWB devices in an energy-efficient manner.

FIG. 4 illustrates an example block diagram of a device comprising a processor in communication with a memory for executing the processes for paging/reconnecting two UWB devices in an energy-efficient manner.

FIG. 5 illustrates an example of a device suitable for paging/reconnecting two UWB devices in an energy-efficient manner.

FIG. 6 illustrates an example flow diagram for paging/reconnecting two WUSB devices both of which follow the ECMA-368 beaconing protocol in an energy-efficient manner.

FIG. 7 illustrates an example of a device suitable for performing the steps illustrated in FIG. 6.

FIG. 8 illustrates an example flow diagram for paging/reconnecting two WUSB devices, wherein only the host device (i.e., paging unit) follows the ECMA-368 beaconing protocol.

FIG. 9 illustrates an example of a device suitable for performing the steps illustrated in FIG. 8.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

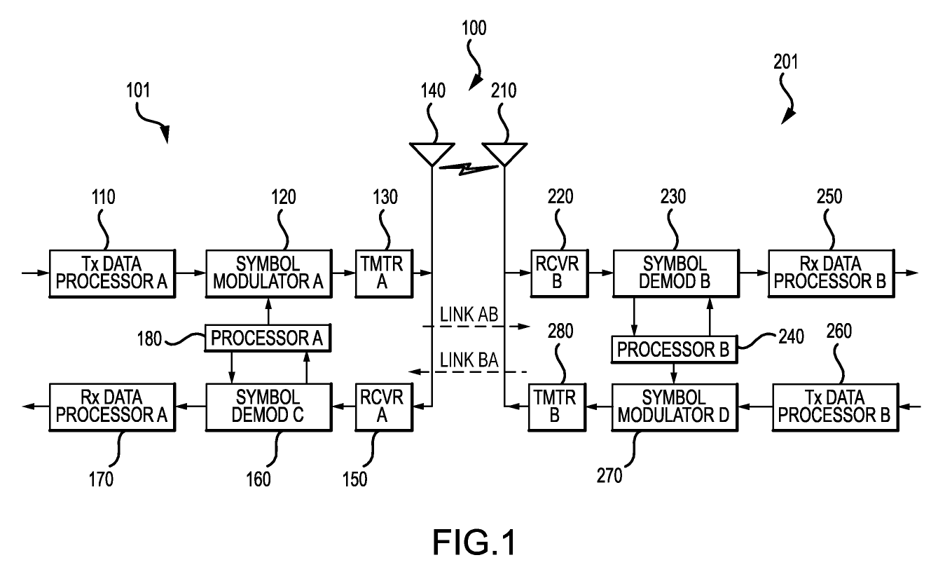

FIG. 1 illustrates an example block diagram of wireless communication system.100. The wireless communication system 100 includes a first user equipment or UE 101 (a.k.a. paging unit) and a second user equipment or UE 201 (a.k.a. scanning unit). In the link AB leg, the first user equipment or UE 101 (a.k.a. paging unit) includes a transmit (TX) data processor A 110 that accepts, formats, codes, interleaves and modulates (or symbol maps) traffic data and provides modulation symbols (a.k.a. data symbols). The TX data processor A 110 is connected to a symbol modulator A 120. The symbol modulator A 120 accepts and processes the data symbols and provides a stream of symbols. In one aspect, symbol modulator A 120 is connected to processor A 180 which provides configuration information. Symbol modulator A 120 is connected to a transmitter unit (TMTR) A 130. The symbol modulator A 120 multiplexes the data symbols and provides them to the transmitter unit A 130.

In one example, in UWB, each OFDM symbol to be transmitted comprises of data and pilot tone. In one aspect, the transmitter unit A 130 receives and converts the stream of symbols into one or more analog signals and further conditions, for example, amplifies, filters and/or frequency upconverts the analog signals, to generate an analog link AB signal suitable for wireless transmission. The analog link AB signal is then transmitted through antenna 140.

In the link AB leg, the second user equipment or UE 201 (a.k.a. scanning unit) includes antenna 210 for receiving the analog link AB signal and inputting the analog link AB signal to a receiver unit (RCVR) B 220. In one aspect, the receiver unit B 220 conditions, for example, filters, amplifies, and frequency downconverts the analog link AB signal to a first “conditioned” signal. The first “conditioned” signal is then sampled. The receiver unit B 220 is connected to a symbol demodulator B 230. The symbol demodulator B 230 demodulates the first “conditioned” and “sampled” signal (a.k.a. data symbols) outputted from the receiver unit B 220. One skilled in the art would understand that an alternative is to implement the sampling process in the symbol demodulator B 230. In one aspect, the symbol demodulator B 230 is connected to a processor B 240. The symbol demodulator B 230 performs data demodulation on the data symbols to obtain data symbol estimates on the link AB path. The data symbol estimates on the link AB path are estimates of the data symbols that were transmitted. The symbol demodulator B 230 is also connected to a RX data processor B 250.

The RX data processor B 250 receives the data symbol estimates on the link AB path from the symbol demodulator B 230 and, for example, demodulates (i.e., symbol demaps), interleaves and/or decodes the data symbol estimates on the link AB path to recover the traffic data. In one aspect, the processing by the symbol demodulator B 230 and the RX data processor B 250 is complementary to the processing by the symbol modulator A 120 and TX data processor A 110, respectively.

In the link BA leg, the transmit and receive processing by TX data processor B 20, symbol modulator D 270, processor B 240, TXTR b 280, RCVR A 150, symbol demodulator C 160 processor A 180 and RX data processor A 170 follow analogous steps in the reverse direction as described for the link AB leg and are not repeated here.

Processor A 180 and processor B 240 direct (i.e., control, coordinate or manage, etc.) operation at the first user equipment or UE 101 (a.k.a. paging unit) and at the second user equipment or UE 201 (a.k.a. scanning unit), respectively. In one aspect, either or both processor A 180 and processor B 240 are associated with one or more memory units (not shown) for storing of program codes and/or data.

In one aspect, for UWB networks, the peer-to-peer wireless connection is between a paging unit and a scanning unit. The paging unit, upon some user interface (UI) trigger, creates a beacon group (BG) and pages the other device, the scanning unit, which looks for the page. The beacon group (BG) typically dwells on one time frequency channel (TFC) for all packets (i.e., within a single channel). However, the UWB paging unit and the scanning unit cannot always assume a priori agreement on which TFC to discover each other. Therefore, there is a need to iterate through a plurality of TFCs.

In one aspect, a goal of the UWB paging/reconnecting procedure is to minimize reconnect time, for example, preferably to around 1.28 sec, which is the 2.4 GHz Bluetooth benchmark. In another aspect, the goal is compliance with the FCC regulatory rules for transmission, which requires that both UWB devices cease transmission within 10 seconds after one of the two UWB devices leaves the connection. Since one or both UWB devices may be battery-powered, it is important that consumed power be minimized during the interim. In one example, the preferred average consumed power is less than 0.5 mW. In addition, energy consumption by both UWB devices during the paging/reconnecting procedure should be minimized, for example, preferably to 50 mW times 1.28 sec (i.e., 50 mW×1.28 sec), for battery-operated devices. In accordance with the UWB paging/reconnecting procedure disclosed herein, minimal, if any, changes to existing wireless standards are needed.

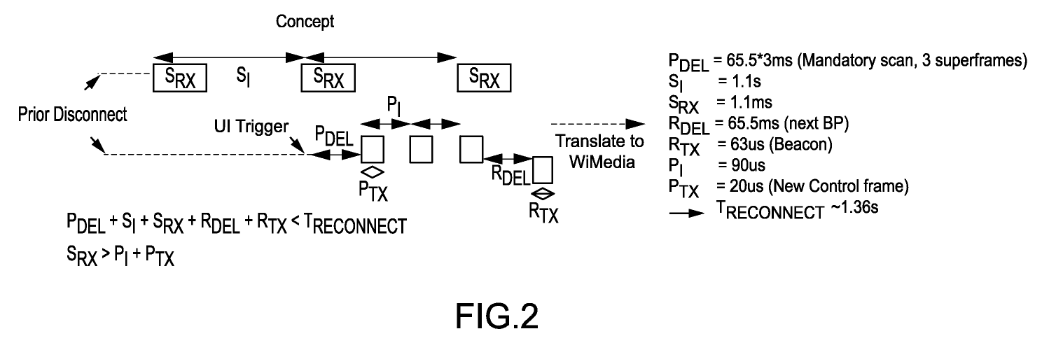

FIG. 2 illustrates an example UWB timeline showing parameters which impact energy efficiency of the UWB devices. The paging delay P_{DEL} is the delay from the UI trigger to when the page transmissions start. The scan interval, S_{I}, is the time interval between successive receive scans. The receive scan duration, S_{RX}, is the time duration of each receive scan. During each receive scan duration S_{RX}, the scanning unit iterates through all TFC channels. For example, if there is N quantity of TFC channels, then the time the scanning unit dwells on each channel looking for a page packet is S_{RX}/N. S_{RX}/N is also known as a predetermined time duration T_{TFC}. The paging interval, P_{I}, is the time interval between successive pages. The transmit duration, P_{TX}, is the time duration of a page packet. The response delay, R_{DEL}, is the time delay after a successful page reception until a response commences. The response duration, R_{TX}, is the time duration of the response.

In the example of FIG. 2, the paging unit starts its first transmit duration, P_{TX}, after the second receive scan duration, S_{RX}, has passed. During both the first and second transmit durations there is no corresponding receive scan duration, S_{RX}. However, the third transmit duration, P_{TX}, coincides with the third receive scan duration, S_{RX}. A response delay, R_{DEL}, occurs before a response from the scanning unit is received by the paging unit during the response duration, R_{TX}. In one example, the following constraint is imposed: P_{DEL}+S_{I}+S_{RX}+R_{DEL}+R_{TX}<T_{RECONNECT}. In one example, T_{RECONNECT} is 1.36 s. In one example, when the quantity of TFC channels is 1 (i.e., N=1) the following constraint is imposed: S_{RX}>P_{I}+P_{TX}. FIG. 2 illustrates the case when N=1. For values of N not equal to 1, S_{RX}/N>P_{I}+P_{TX} or T_{TFC}>P_{I}+P_{TX}FIG. 2 also shows some example values of the various parameters.

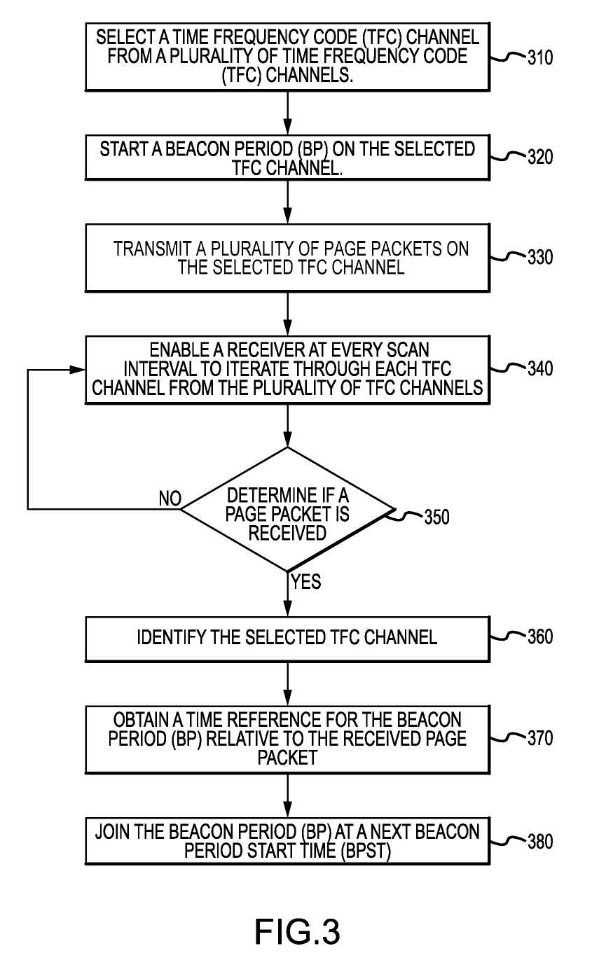

FIG. 3 illustrates an example flow diagram for paging/reconnecting two UWB devices (e.g., a paging unit and a scanning unit) in an energy-efficient manner. In block 310, select a time frequency code (TFC) channel from a plurality of TFC channels. In one aspect, the TFC channel to be selected (i.e., the selected TFC channel) is pre-specified. For example, the two UWB devices specify the TFC channel for subsequent reconnection when the two UWB devices are first connected. The selected TFC channel is the channel on which the paging unit will create a beacon group and transmit page packets to the scanning unit. In one aspect, block 310 also includes the pre-scan as required by ECMA 368. Following block 310, in block 320, start a beacon period (BP) on the selected TFC channel. In one example, the beacon period (BP) is started on the selected TFC channel based on ECMA368. Next, in block 330, transmit the plurality of page packets on the selected TFC channel after the beacon period (BP) in each superframe. For example, as defined in ECMA-368, each superframe has a beacon period (BP) followed by data transmissions. During the beacon period (BP), only standard ECMA-368 beacons can be sent. The page packets are sent during the data portion of each superframe.

In block 340, enable a receiver within one of the UWB devices per scan interval to iterate through each TFC channel from the plurality of TFC channels from which the selected TFC channel was selected (i.e., enable a receiver to iterate through each of the plurality of TFC channels per scan interval). In one example, the receiver is enabled to iterate fully through each of the plurality of TFC channels. In another example, the receiver is enabled to iterate partially through each of the plurality of TFC channels. One skilled in the art would understand that the choice of a full or a partial iteration process can be varied according to system parameters or application parameters without affecting the scope or spirit of the present disclosure. In the example where the selected TFC channel is pre-specified, there is no iteration.

In one aspect, the receiver dwells on each TFC channel for a predetermined time duration T_{TFC}. In one example, the predetermined time duration T_{TFC} is longer than the time duration P_{TX} of each page packet plus the time interval P_{I} between successive page packets (i.e., T_{TFC}>P_{TX}+P_{I}). Setting T_{TFC}>P_{TX}+P_{I} ensures that a page packet will be received within one scan interval. In one example, the receiver is a component within a scanning unit. T_{TFC} is the receive scan duration S_{RX} divided by the N quantity of TFC channels, i.e., S_{RX}/N.

Following block 340, in block 350, determine if a page packet is received. If no page packet is received, return to block 340. If a page packet is received, proceed to block 360. In one aspect, block 350 also includes receiving the page packet. In block 360, identify the selected TFC channel. In one aspect, the selected TFC channel is identified as the TFC channel on which the page packet was successfully received in block 350.

Following block 360, in block 370, obtain the time reference for the beacon period (BP) relative to the received page packet. In one example, the payload of the page packet conveys a BP-relative timestamp. Also, in one example, the payload of the page packet includes information wherein the paging unit can optionally identify the intended recipient of the page. In block 380, join the beacon period (BP) at the next beacon period start time (BPST). In one example, the procedures specified in ECMA368 are followed. Following block 380, the two UWB devices are now reconnected. In one aspect, the UWB devices are configured so such that one device is in paging mode and the other device is in scanning mode so that the paging unit executes the steps described in blocks 310, 320 and 330, and the scanning unit executes the steps described in blocks 340, 350, 360, 370 and 380. In one aspect, a UWB system device comprising a paging function and a scanning function performs the steps illustrated in FIG. 3.

With appropriate values for the various parameters, for example the parameters shown in FIG. 2, the scanning unit ensures that it catches a page packet within one scan interval. By knowing the TFC channel on which it received the page packet, the scanning unit knows the TFC channel for the BP it needs to join to connect with the paging unit. The beacon period start time (BPST) for the desired beacon group is known from the payload portion of the page packet in conjunction with the time instant when the page packet was received. That is, the payload of each page packet conveys the BPST relative to the time of transmission of the page packet.

Since the example paging/reconnecting procedure as illustrated in FIG. 3 does not rely on UWB beacons for rediscovery, energy consumption on both UWB devices is minimized until there is a need to reconnect. In one aspect, the paging/reconnecting procedure also ceases all transmissions as required by the Federal Communications Commission (FCC). By the paging unit first establishing the BP on a suitable TFC channel (i.e., selected TFC channel), and then sending page packets only on the selected TFC channel, it shifts the burden of iterating through the plurality of TFC channels to the scanning unit. Thus, the paging/reconnecting procedure avoids the need to pre-scan every TFC channel and prepare a BP for each TFC channel before attempting to page on each TFC channel.

In one aspect, the paging/reconnecting procedure for UWB devices illustrated in FIG. 3 is used for various wireless standards such as but not limited to WUSB (Wireless USB or Wireless Universal Serial Bus), WLP (Wimedia Logical Link Control Protocol), native applications on ECMA-368 MAC, etc. In one example, the implementation includes one active device (i.e., transmitting) and one passive device (i.e., receiving). Examples of wireless devices include but are not limited to a personal computer/dock, hard disk drive (HDD) storage, printer, projector/display, notebook computer, mobile phone, ultra-mobile PC (UMPC), digital camera, etc.

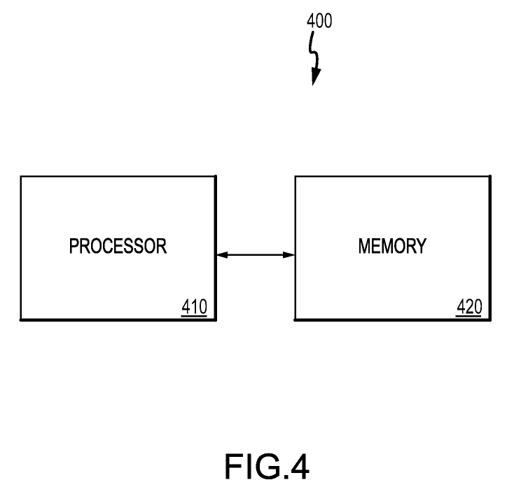

FIG. 4 illustrates an example of a device 400 comprising a processor 410 in communication with a memory 420 for executing the processes for paging/reconnecting two UWB devices in an energy-efficient manner. In one example, the device 400 is used to implement the algorithm illustrated in FIG. 3. In one aspect, the memory 420 is located within the processor 410. In another aspect, the memory 420 is external to the processor 410. In one aspect, the processor includes circuitry for implementing or performing the various flow diagrams, logical blocks and/or modules described herein.

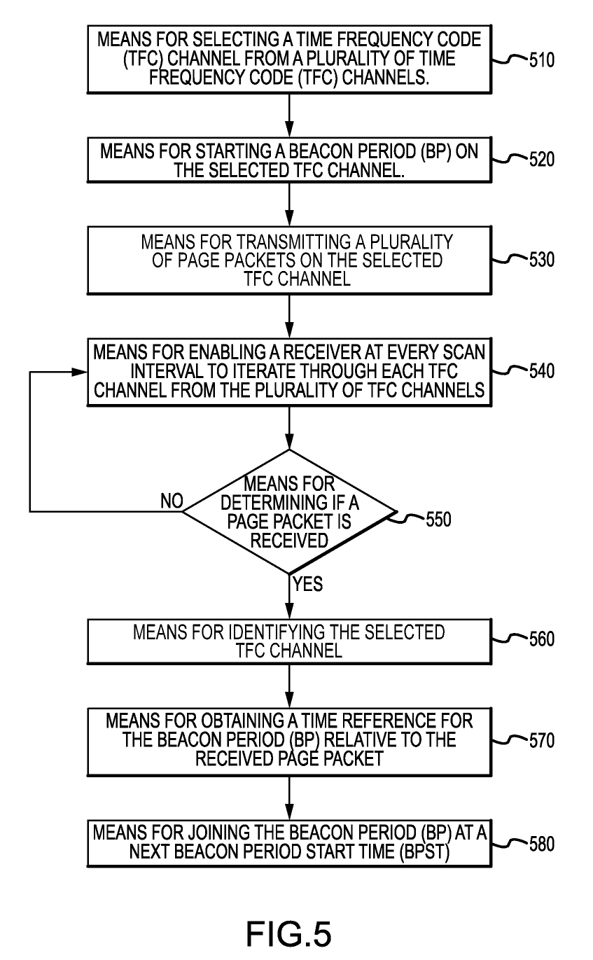

FIG. 5 illustrates an example of a device 500 suitable for paging/reconnecting two UWB devices in an energy-efficient manner. In one aspect, the device 500 is implemented by at least one processor comprising one or more modules configured to provide different aspects of paging/reconnecting two UWB devices in an energy-efficient manner as described herein in blocks 510, 520, 530, 540, 550, 560, 570 and 580. For example, each module comprises hardware, firmware, software, or any combination thereof. In one aspect, the device 500 is also implemented by at least one memory in communication with the at least one processor.

Two cases of a WUSB system are illustrated herein. In a first case, the steps illustrated in the flow diagram in FIG. 3 are applicable to the WUSB system comprising two WUSB devices communicating with each other following the ECMA-368 beaconing protocol. In one example, one of the two WUSB devices (e.g., WUSB host device) is the paging unit while the other WUSB device (e.g., WUSB peripheral device) is the scanning unit. The WUSB peripheral device may be a self beaconing device.

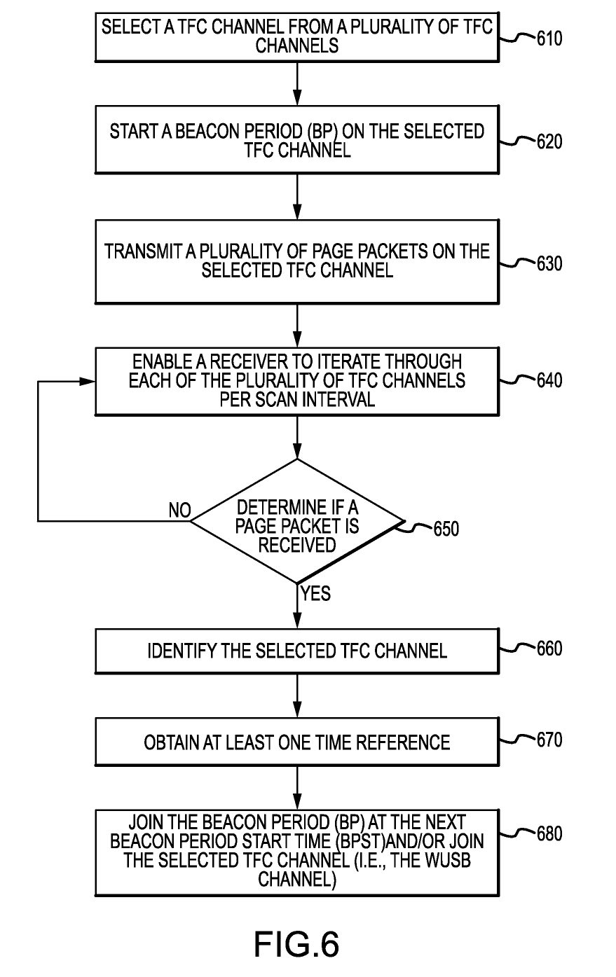

FIG. 6 illustrates an example flow diagram for paging/reconnecting two WUSB devices both of which follow the ECMA-368 beaconing protocol in an energy-efficient manner. In block 610, select a TFC channel from a plurality of TFC channels. In one aspect, the TFC channel to be selected (i.e., the selected TFC channel) is pre-specified. For example, the two devices specify a TFC channel for subsequent reconnection when the two devices are first connected. The selected TFC channel is the channel on which the paging unit will transmit page packets to the scanning unit. Following block 610, in block 620, start a beacon period (BP) on the selected TFC channel. In one aspect, also start a wireless USB (i.e., WUSB) channel on the same selected TFC channel.

Next, in block 630, transmit a plurality of page packets on the selected TFC channel wherein each of the page packets is a Micro-Scheduled Management Command (MMC). In one aspect, the MMC which is sent by the host, provides at least one of the following: a time stamp for the next MMC to be sent by the host (“a first time stamp”); a next Device Notification Time Slot (DNTS) when a peripheral device is allowed to send a connect request message, and/or a time stamp for the next beacon period (BP) (“second time stamp”).

In block 640, enable a receiver within one of the two devices per scan interval to iterate (either fully or partially) through each TFC channel from the plurality of TFC channels from which the selected channel was selected (i.e., enable a receiver to iterate through each of the plurality of TFC channels per scan interval). In the example where the selected TFC channel is pre-specified, there is no iteration. Following block 640, in block 650, determine if a page packet is received. If no page packet is received, return to block 640. If a page packet is received, proceed to block 660. In one aspect, block 650 also includes receiving the page packet. In block 660, identify the selected TFC channel. In one aspect, the selected TFC channel is identified as the TFC channel on which the page packet was successfully received in block 650. In the example where the two devices (e.g., paging and scanning units) specify the TFC channel for subsequent reconnection when the two devices are first connected, then the selected TFC channel is the pre-specified TFC channel.

Following block 660, in block 670, obtain a time reference (“first time reference”) for the BP relative to the received page packet. In one aspect, also obtain a time reference (“second time reference”) for the next MMC. In yet another aspect, also obtain a time reference (“third time reference”) for the next DNTS. In block 680, join the beacon period (BP) at the next beacon period start time (BPST). In one aspect, also join the selected TFC channel (i.e., the WUSB channel) by sending a connect request message at the next DNTS. Following block 680, the two devices are now reconnected.

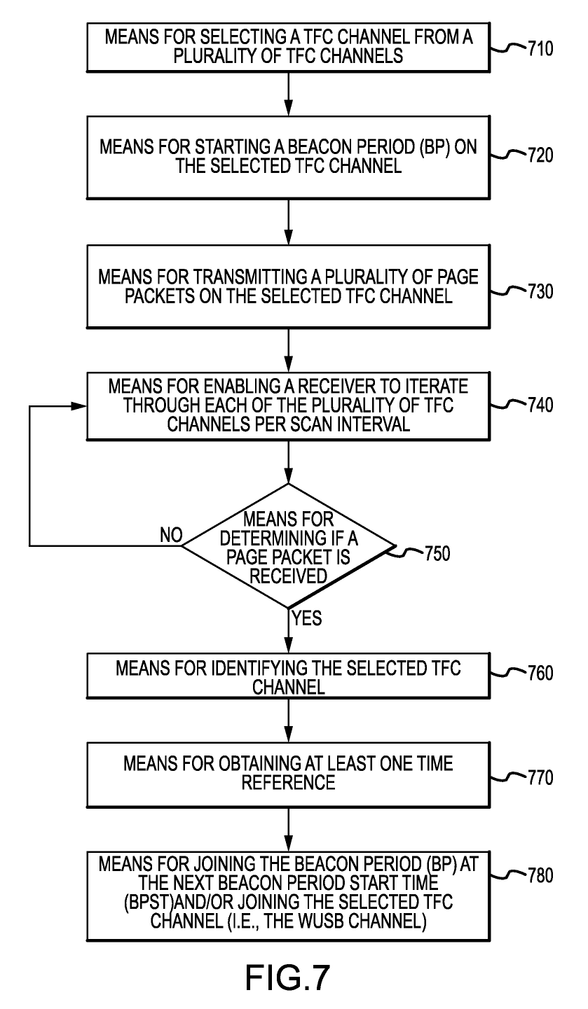

FIG. 7 illustrates an example of a device 700 suitable for performing the steps illustrated in FIG. 6. In one aspect, the device 700 is implemented by at least one processor comprising one or more modules configured to provide different aspects of paging/reconnecting two devices in an energy-efficient manner as described herein in blocks 710, 720, 730, 740, 750, 760, 770 and 780. For example, each module comprises hardware, firmware, software, or any combination thereof. In one aspect, the device 700 is also implemented by at least one memory in communication with the at least one processor.

The second case of a WUSB system is illustrated herein. In the second case, the WUSB system comprises two WUSB devices communicating with each other; however, only the host device (i.e., the paging unit) follows the ECMA-368 beaconing protocol. The peripheral device (i.e., scanning unit) does not track ECMA-368 beacons or transmit beacons. In one aspect, the peripheral device is a non-beaconing device. In another aspect, the peripheral device is a directed beaconing WUSB peripheral device.

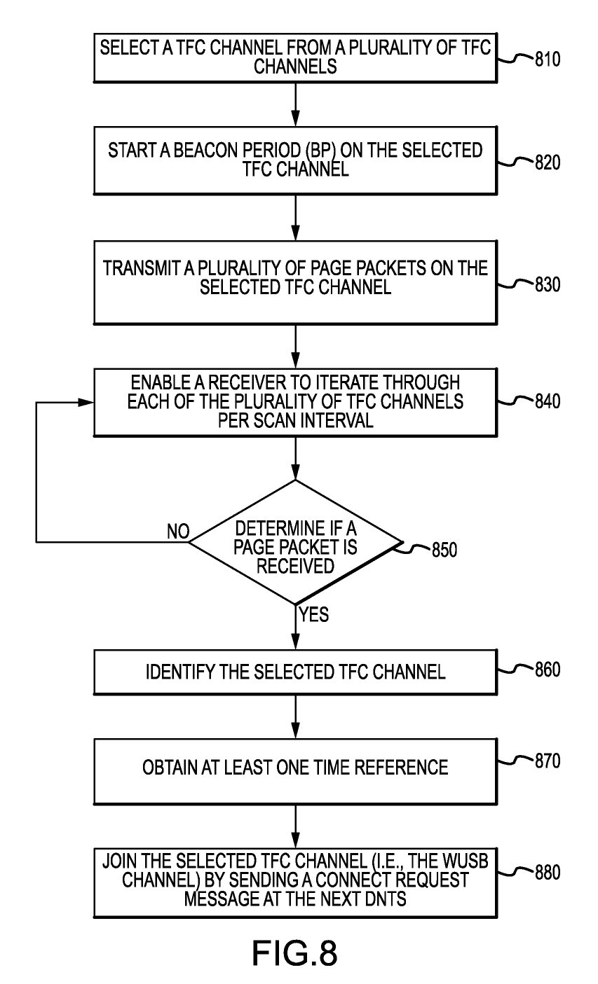

FIG. 8 illustrates an example flow diagram for paging/reconnecting two WUSB devices, wherein only the host device (i.e., paging unit) follows the ECMA-368 beaconing protocol. The peripheral device is a non-beaconing device or a directed beaconing WUSB peripheral device. In block 810, select a TFC channel from a plurality of TFC channels. In one aspect, the TFC channel to be selected (i.e., the selected TFC channel) is pre-specified. For example, the two devices specify the TFC channel for subsequent reconnection when the two devices are first connected. The selected TFC channel is the channel on which the paging unit will transmit page packets to the scanning unit. Following block 810, in block 820, start a beacon period (BP) on the selected TFC channel. In one aspect, also start a wireless USB (i.e., WUSB) channel on the same selected TFC channel.

Next, in block 830, transmit a plurality of page packets on the selected TFC channel wherein each of the page packets is a Micro-Scheduled Management Command (MMC). In one aspect, the MMC which is sent by the host, provides at least one of the following: a time stamp for the next MMC to be sent by the host (“a first time stamp”); a next Device Notification Time Slot (DNTS) when a peripheral device is allowed to send a connect request message, and/or a time stamp for the next beacon period (BP) (“second time stamp”).

In block 840, enable a receiver within one of the two devices per scan interval to iterate (either fully or partially) through each TFC channel from the plurality of TFC channels from which the selected TFC channel was selected (i.e., enable a receiver to iterate through each of the plurality of TFC channels per scan interval). In the example where the selected TFC channel is pre-specified, there is no iteration. Following block 840, in block 850, determine if a page packet is received. If no page packet is received, return to block 840. If a page packet is received, proceed to block 860. In one aspect, block 850 also includes receiving the page packet. In block 860, identify the selected TFC channel. In one aspect, the selected TFC channel is identified as the channel on which the page packet was successfully received in block 850. In the example where the two devices (e.g., paging and scanning units) specify the TFC channel for subsequent reconnection when the two devices are first connected, then the selected TFC channel is the pre-specified TFC channel.

Following block 860, in block 870, obtain a time reference (“first time reference”) for the next DNTS. In one aspect, also obtain a time reference (“second time reference”) for the next MMC. In block 880, join the selected TFC channel (i.e., the WUSB channel) by sending a connect request message at the next DNTS. Following block 880, the two devices are now reconnected.

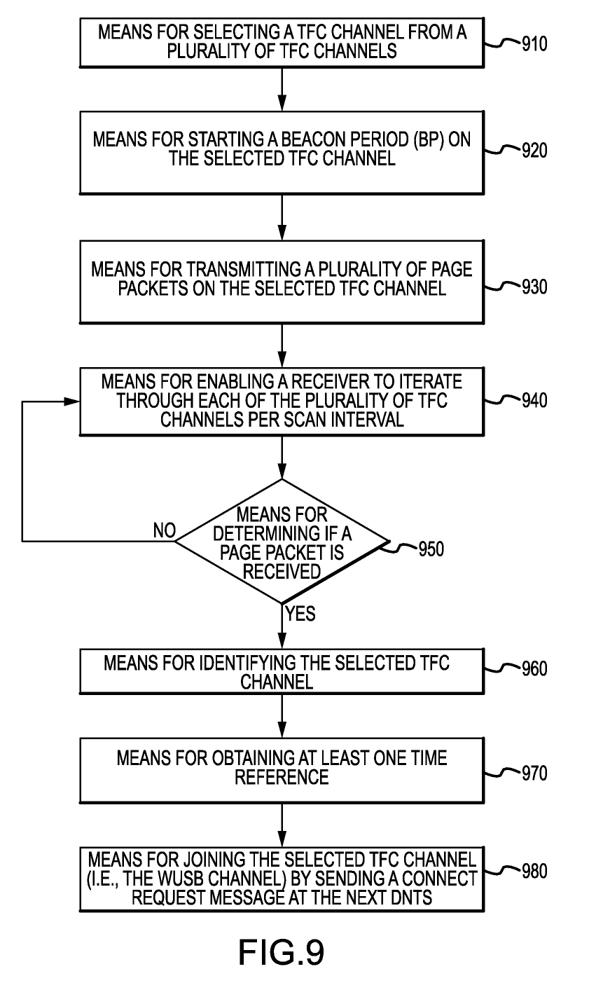

FIG. 9 illustrates an example of a device 900 suitable for performing the steps illustrated in FIG. 8. In one aspect, the device 900 is implemented by at least one processor comprising one or more modules configured to provide different aspects of paging/reconnecting two devices in an energy-efficient manner as described herein in blocks 910, 920, 930, 940, 950, 960, 970 and 980. For example, each module comprises hardware, firmware, software, or any combination thereof. In one aspect, the device 900 is also implemented by at least one memory in communication with the at least one processor.

One skilled in the art would understand that steps may be added to the example flow diagram in FIG. 3 without affecting the spirit or scope of the present disclosure since the steps illustrated in FIG. 3 are not exclusive. Similarly, some of the steps illustrated in FIG. 3 may be deleted or modified without affecting the spirit or scope of the present disclosure. Furthermore, one skilled in the art would understand that some of the steps of the flow diagram illustrated in FIG. 3 may be interchanged in their order without affecting the scope or spirit of the present disclosure.

Those of skill would further appreciate that the various illustrative components, logical blocks, modules, circuits and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for paging and reconnecting two UWB devices, the method comprising:
selecting a time frequency code (TFC) channel from a plurality of TFC channels;
starting a beacon period (BP) on the selected TFC channel; and
transmitting a plurality of page packets on the selected TFC channel.

2. The method of claim 1 wherein the steps of claim 1 are consistent with one of the following wireless standards: WUSB (Wireless Universal Serial Bus), WLP (Wimedia Logical Link Control Protocol) or native applications on ECMA-368 MAC.

3. The method of claim 1 wherein the beacon period (BP) is started on the selected TFC channel based on ECMA368 beaconing protocol.

4. The method of claim 1 wherein each of the plurality of page packets is a Micro-Scheduled Management Command (MMC).

5. The method of claim 4 wherein the MMC provides at least one of a first time stamp for a next MMC to be transmitted, a next Device Notification Time Slot (DNTS) when a peripheral device is allowed to send a connect request message, or a second time stamp for a next beacon period (BP).

6. The method of claim 1 further comprising pre-specifying the selected TFC channel during a first connection between the two UWB devices.

7. The method of claim 1 further comprising enabling a receiver in one of the two UWB devices to iterate through each of the plurality of TFC channels per scan interval.

8. The method of claim 7 wherein the receiver dwells on each of the plurality of TFC channels for a predetermined time duration T_{TFC}.

9. The method of claim 8 wherein the predetermined time duration T_{TFC} is longer than the time duration P_{TX} of each of the plurality of page packets plus the time interval PI between successive page packets.

10. The method of claim 1 further comprising receiving at least one page packet from the plurality of page packets and identifying the selected TFC channel.

11. The method of claim 10 further comprising obtaining a time reference for the beacon period (BP) wherein the time reference is based on one of the plurality of page packets.

12. The method of claim 11 wherein one of the plurality of page packets contains information that identifies the intended recipient of the at least one page packet.

13. The method of claim 11 further comprising joining the beacon period (BP) at a next beacon period start time (BPST).

14. The method of claim 13 further comprising joining the selected TFC channel by sending a connect request message at a next device notification time slot (DNTS).

15. The method of claim 11 further comprising obtaining at least one of a second time reference for a next device notification time slot (DNTS).

16. The method of claim 15 further comprising obtaining at least one of a third time reference for a next Micro-Scheduled-Management Command (MMC).

17. A method for reconnecting two UWB devices, the method comprising:
receiving at least one page packet from a plurality of page packets;
identifying a selected time frequency code (TFC) channel from a plurality of TFC channels;
obtaining at least one time reference; and
performing one of joining a beacon period (BP) at a next beacon period start time (BPST) or joining the selected TFC channel by sending a connect request message at a next device notification time slot (DNTS).

18. The method of claim 17 wherein the selected TFC channel was pre-specified during a first connection between the two UWB devices.

19. The method of claim 17 further comprising enabling a receiver in one of the two UWB devices to iterate through each of the plurality of TFC channels per scan interval.

20. The method of claim 19 wherein the receiver dwells on each of the plurality of TFC channels for a predetermined time duration T_{TFC}.

21. The method of claim 20 wherein the predetermined time duration T_{TFC} is longer than the time duration P_{TX} of each of the plurality of page packets plus the time interval PI between successive page packets.

22. The method of claim 17 wherein obtaining at least one time reference comprises obtaining a time reference for the beacon period (BP).

23. The method of claim 22 wherein joining the beacon period (BP) at the next beacon period start time (BPST) is performed.

24. The method of claim 17 wherein joining the selected TFC channel by sending a connect request message at a next device notification time slot (DNTS) is performed.

25. The method of claim 22 wherein obtaining at least one time reference further comprises obtaining a second time reference for a next device notification time slot (DNTS).

26. The method of claim 25 wherein obtaining at least one time reference further comprises obtaining a third time reference for a next Micro-Scheduled-Management Command (MMC).

27. The method of claim 17 wherein a first of the two UWB devices is a paging unit in a WUSB wireless system and wherein the paging unit follows the ECMA368 beaconing protocol, and wherein a second of the two UWB devices is a scanning unit in the WUSB wireless system and wherein the scanning unit is a non-beaconing device or a directed beaconing WUSB peripheral device.

28. The method of claim 27 wherein obtaining at least one time reference further comprises obtaining a time reference for a next device notification time slot (DNTS).

29. The method of claim 28 wherein joining the selected TFC channel by sending a connect request message at a next device notification time slot (DNTS) is performed.

30. The method of claim 29 further comprising obtaining a second time reference for a next MMC.

31. An apparatus for paging and reconnecting, the apparatus comprising:
at least one processor and circuitry configured to:
select a time frequency code (TFC) channel from a plurality of TFC channels;
start a beacon period (BP) on the selected TFC channel; and
transmit a plurality of page packets on the selected TFC channel.

32. The apparatus of claim 31 wherein the apparatus follows one of the following wireless standards: WUSB (Wireless Universal Serial Bus), WLP (Wimedia Logical Link Control Protocol) or native applications on ECMA-368 MAC.

33. The apparatus of claim 31 wherein the beacon period (BP) is started on the selected TFC channel based on ECMA368 beaconing protocol.

34. The apparatus of claim 31 wherein each of the plurality of page packets is a Micro-Scheduled Management Command (MMC).

35. The apparatus of claim 34 wherein the MMC provides at least one of a first time stamp for a next MMC to be transmitted, a next Device Notification Time Slot (DNTS) when a peripheral device is allowed to send a connect request message, or a second time stamp for a next beacon period (BP).

36. The apparatus of claim 31 wherein the at least one processor and circuitry are further configured to pre-specify the selected TFC channel during a first connection.

37. The apparatus of claim 31 wherein the at least one processor and circuitry are further configured to enable a receiver within the apparatus to iterate through each of the plurality of TFC channels per scan interval.

38. The apparatus of claim 37 wherein the receiver dwells on each of the plurality of TFC channels for a predetermined time duration T_{TFC}.

39. The apparatus of claim 31 wherein the at least one processor and circuitry are further configured to receive at least one page packet from the plurality of page packets (350) and to identify the selected TFC channel.

40. The apparatus of claim 31 wherein one of the plurality of page packets contains information that identifies the intended recipient of the at least one page packet.

41. The apparatus of claim 39 wherein the at least one processor and circuitry are further configured to obtain a time reference for a next device notification time slot (DNTS).

42. The apparatus of claim 41 wherein the at least one processor and circuitry are further configured to join the selected TFC channel by sending a connect request message at the next DNTS.

43. The apparatus of claim 42 wherein the at least one processor and circuitry are further configured to obtain a second time reference for a next MMC.

44. An apparatus for reconnecting, the apparatus comprising:
at least one processor and circuitry configured to:
receive at least one page packet from a plurality of page packets;
identify a selected TFC channel from a plurality of TFC channels;
obtain at least one time reference; and
perform one of joining a beacon period (BP) at a next beacon period start time (BPST) or joining the selected TFC channel by sending a connect request message at a next device notification time slot (DNTS).

45. The apparatus of claim 44 wherein the selected TFC channel was pre-specified during a first connection.

46. The apparatus of claim 44 wherein the at least one processor and circuitry are further configured to enable a receiver within the apparatus to iterate through each of the plurality of TFC channels per scan interval.

47. The apparatus of claim 46 wherein the receiver dwells on each of the plurality of TFC channels for a predetermined time duration T_{TFC}.

48. The apparatus of claim 47 wherein the predetermined time duration T_{TFC} is longer than the time duration P_{TX} of each of the plurality of page packets plus the time interval P_{I} between successive page packets.

49. The apparatus of claim 44 wherein to obtain at least one time reference comprises obtaining a time reference for the beacon period (BP).

50. The apparatus of claim 49 wherein to join the beacon period (BP) at the next beacon period start time (BPST) is performed.

51. The apparatus of claim 44 wherein joining the selected TFC channel by sending a connect request message at a next device notification time slot (DNTS) is performed.

52. The apparatus of claim 49 wherein to obtain at least one time reference further comprises obtaining a second time reference for a next device notification time slot (DNTS).

53. The apparatus of claim 52 wherein to obtain at least one time reference further comprises obtaining a third time reference for a next Micro-Scheduled-Management Command (MMC).

54. The apparatus of claim 44 wherein to obtain at least one time reference further comprises obtaining a time reference for a next device notification time slot (DNTS).

55. The apparatus of claim 54 wherein joining the selected TFC channel by sending a connect request message at a next device notification time slot (DNTS) is performed.

56. The apparatus of claim 55 wherein the at least one processor and circuitry are further configured to obtain a second time reference for a next MMC.

57. A UWB device for paging and reconnecting, the device comprising:
means for selecting a time frequency code (TFC) channel from a plurality of TFC channels;
means for starting a beacon period (BP) on the selected TFC channel; and
means for transmitting a plurality of page packets on the selected TFC channel.

58. A UWB device for reconnecting, the device comprising:
means for receiving at least one page packet from a plurality of page packets;
means for identifying a selected TFC channel from a plurality of TFC channels;
means for obtaining at least one time reference; and
means for performing one of joining a beacon period (BP) at a next beacon period start time (BPST) or joining the selected TFC channel by sending a connect request message at a next device notification time slot (DNTS).

59. A computer program product, comprising:
computer-readable medium comprising:
code for causing a computer to select a time frequency code (TFC) channel from a plurality of TFC channels;
code for causing a computer to start a beacon period (BP) on the selected TFC channel; and
code for causing a computer to transmit a plurality of page packets on the selected TFC channel.

60. A computer program product, comprising:
computer-readable medium comprising:
code for causing a computer to receive at least one page packet from a plurality of page packets;
code for causing a computer to identify a selected TFC channel from a plurality of TFC channels;
code for causing a computer to obtain at least one time reference; and
code for causing a computer to perform one of joining a beacon period (BP) at a next beacon period start time (BPST) or joining the selected TFC channel by sending a connect request message at a next device notification time slot (DNTS).
